(19) United States
(12) Patent Application Publication
(10) Pub. No.: US 2006/0224251 A1
(43) Pub. Date: Oct. 5, 2006

(54) Duplex system and method of switching control right in duplex system

(75) Inventor: Takenori Ichinose, Tokyo (JP)

Correspondence Address: EDWARDS & ANGELL, LLP, P.O. BOX 55874, BOSTON, MA, 02205, US

(73) Assignee: Yokogawa Electric Corporation, Tokyo (JP)

(21) Appl. No.: 11/393,149

(22) Filed: Mar. 29, 2006

(30) Foreign Application Priority Data
Mar. 31, 2005 (JP) 2005-104529

(51) Int. Cl. G05B 15/00

(52) U.S. Cl. 700/1

(57) ABSTRACT

A duplex system has a control station which has a pair of input/output modules duplicated on control and standby sides, which is disposed between a higher-level device and a lower-level device, and which sends and receives data. The duplex system further has a module information storing section which stores information of the pair of input/output modules provided in the control station, a module information displaying section which displays information stored in the module information storing section, a selecting section which selects at least one pair out of input/output modules displayed on the module information displaying section, and a switching section which switches a control right of the pair of input/output modules selected by the selecting section from the control side to the standby side.

### CROSS-REFERENCE TO RELATED APPLICATIONS

This application is based upon and claims the benefit of priority from the prior Japanese Patent Applications No. 2005-104529, filed on Mar. 31, 2005, the entire contents of which are incorporated herein by reference.

### BACKGROUND OF THE INVENTION

1. Field of the Invention

The present invention relates to a duplex system to be used in, for example, a plant control system, and having a control station which has a pair of input/output modules duplicated on control and standby sides, which is disposed between a higher-level device and a lower-level device, and which sends and receives data, and a method of switching a control right in such a duplex system, and more particularly to a duplex system and method of switching the control right in a duplex system in which the control right of duplicated input/output modules can be easily switched.

2. Description of the Related Art

A plant control system which performs a control, an operation, a manipulation, a monitoring, and the like on a plant is configured by, for example, a device (control system) for optimumly operating the plant, and a device (security system) for, when an abnormality occurs in the plant, safely shutting down the operation of the plant.

Since a failure of a plant control system directly affects the operation of a plant, the control system is requested to have very high reliability. In order to enhance reliability and security, therefore, devices and communication paths in a related-art system are duplicated. A system in which such duplication is conducted is called a duplex system.

FIG. 6 is a diagram showing the configuration of a related-art duplicated plant control system. Referring to FIG. 6, an operation monitor station (hereinafter, referred to as HIS (Human Interface Station)) 10 performs an operation, a monitoring, and the like on a plant.

Control stations (hereinafter, referred to as FCSs (Field Control Stations) 20(1) to 20(n) are distributed in the plant. Specifically, the control stations are disposed between the HIS 10 and field devices (disposed in the plant), and communicate with the HIS 10 and the field devices to send and receive data. The HIS 10 is a higher-level device with respect to the FCSs 20(1) to 20(n), and the field devices are lower-level devices. Each of the FCSs 20(1) to 20(n) has nodes 21(1) to 21(3) in each of which plural modules are stored. The modules in the nodes 21(1) to 21(3) perform communication with the field devices and the HIS 10, processing of transmitted and received data, etc.

FIG. 7 is a diagram showing an example of the nodes 21(1) to 21(3). A case 22 of each of the nodes 21(1) to 21(3) houses plural modules such as input/output modules 23a, 23b, CPU modules 24a, 24b, and power source module 25a, 25b. The modules 23a to 25a, and 23b to 25b are duplicated, so that the modules 23a, 24a, 25a are on the control side which is normally used, and the modules 23b, 24b, 25b are on the standby side.

The input/output modules 23a, 23b communicate with the field devices and the HIS 10 to send and receive data. The CPU modules 24a, 24b perform control on the nodes 21(1) to 21(3), and the like.

The operation of the system will be described. Date sent from the field devices are monitored in a centralized way by the HIS 10 via the modules 23a to 25a on the control side of the FCSs 20(1) to 20(n). The operator operates the HIS 10 to operate and control the field devices via the modules 23a to 25a of the FCSs 20(1) to 20(n), thereby controlling the plant.

When an abnormality occurs in the plant, the operator shuts down, or the HIS 10 automatically shuts down the plant via the modules 23a to 25a of the FCSs 20(1) to 20(n).

Next, the operation in the case where an abnormality occurs in the modules 23a to 25a will be described. When an abnormality occurs in the modules 23a to 25a on the control side, module monitoring section which is not shown detects the abnormality, and control is automatically switched from the modules 23a to 25a on the control side in which the abnormality occurs, to the modules 23b to 25b on the standby side. In place of the modules 23a to 25a, the modules 23b to 25b which obtain control start the control procedure on the plant, and the like. Even when an abnormality occurs in the control side, therefore, the operation of the plant is not interrupted.

Next, the case where the plant undergoes periodic inspection, modification, or the like will be described.

In the case where the field devices or the input/output modules 23a to 25a and 23b to 25b are to be replaced in the operation state of the plant, i.e., a state where the plant is operating, control must be switched from the control side to the standby side. Therefore, the input/output modules 23a to 25a on the control side are physically detached from control station or the FCSs 20(1) to 20(n) (namely, the control side is set to an abnormal state), whereby control is switched to the standby side. Thereafter, periodic inspection is performed.

JP-A-10-65726 and JP-A-2003-186692 are referred to as related art.

However, the HIS 10 is often placed in a supervision room which is remote from the plant, and therefore the HIS 10 and the FCSs 20(1) to 20(n) are disposed in separate places. In order to check whether a control right of the FCSs 20(1) to 20(n) is switched or not, therefore, there arises the following problem. The operator must shuttle many times between the HIS 10 and the FCSs 20(1) to 20(n), or an operator who attaches or detaches the modules 23a to 25a and 23b to 25b, and another operator who monitors the HIS 10 are necessary.

The attaching and detaching of the modules 23a to 25a and 23b to 25b are naturally conducted one by one of the modules 23a to 25a and 23b to 25b. In the case where the plant has many modules 23a to 25a and 23b to 25b, there is a problem in that it takes a long time to perform switching of control on all the modules 23a to 25a and 23b to 25b.

There is a further problem in that, when the modules 23a to 25a and 23b to 25b are attached and detached, the modules 23a to 25a or 23b to 25b may be erroneously broken. Particularly, many field devices are connected to the input/output modules 23a, 23b, and hence a large number of modules are used.

### SUMMARY OF THE INVENTION

An object of the invention is to provide a duplex system and a method of switching a control right in a duplex system in which the control right of duplicated input/output modules can be easily switched.

The invention provides a duplex system having:

a control station which has a pair of input/output modules duplicated on control and standby sides, which is disposed between a higher-level device and a lower-level device, and which sends and receives data;

a module information storing section which stores information of the pair of input/output modules provided in the control station;

a module information displaying section which displays information stored in the module information storing section;

a selecting section which selects at least one pair our of input/output modules displayed on the module information displaying section; and

a switching section which switches a control right of the pair of input/output modules selected by the selecting section from the control side to the standby side.

In the duplex system, the module information storing section stores as least one of an identifier, a type, and an installation place of each of the pair of input/output modules, as the information.

In the duplex system, the module information displaying section displays the information in a unit of a control station, a node in a control station, or a pair of input/output modules.

In the duplex system, the selecting section selects a pair of input/output modules in a unit of a control station, a node in a control station, or a pair of input/output modules.

In the duplex system, the module information displaying section displays the information with a tree structure.

The duplex system further has a status displaying section which displays a switching status of a control right of a pair of input/output modules.

In the duplex system, the status displaying section displays at least one of a pair of input/output modules for which a switching process is performed, a starting time of the switching process, a result of the switching process, an ending time of the switching process, and a switching error.

In the duplex system, the duplex system is used in a plant control system.

The invention also provides a method of switching a control right in a duplex system having a control station which has a pair of input/output modules duplicated on control and standby sides, which is disposed between a higher-level device and a lower-level device, and which sends and receives data, having the steps of:

storing information of the pair of input/output modules provided in the control station, into a module information storing section;

reading information stored in the module information storing section to display a list of pairs of input/output modules;

selecting at least one pair out of input/output modules displayed; and switching a control right of the pair of input/output modules selected from the control side to the standby side.

According to the duplex system, the selecting section selects at least one pair out of the input/output modules displayed on a display screen by the module information displaying section. Then, the switching section switches the control right of the pair of input/output modules selected by the selecting section, from the control side to the standby side. Therefore, the operator is not required to shuttle between the higher-level device and the control stations, or it is not necessary to deploy operators respectively in the higher-level device and the control stations. Consequently, the control right of the input/output modules can be easily switched. Since the input/output modules are not required to be detached, a situation where a detached input/output module is erroneously attached to a wrong position, or where an input/output module is broken during an attaching or detaching process does not occur.

Further, the selecting section selects a pair of input/output modules in the unit of the control station or the node in the control station, and the switching section switches the control right in the selected unit. Therefore, switching among plural input/output modules can be instantaneously performed.

According to the method of switching the control right in the duplex system, the information stored in the module information storing section is read out, input/output modules are displayed in the form of a list, at least one pair out of the displayed input/output modules is selected, and the control right of the selected pair of input/output modules is switched from the control side to the standby side. Therefore, the operator is not required to shuttle between the higher-level device and the control stations, or it is not necessary to deploy operators respectively in the higher-level device and the control stations. Consequently, the control right of the input/output modules can be easily switched. Since the input/output modules are not required to be detached, a situation where a detached input/output module is erroneously attached to a wrong position, or where an input/output module is broken during an attaching or detaching process does not occur.

### BRIEF DESCRIPTION OF THE DRAWINGS

FIG. 1 is a diagram showing the configuration of an embodiment of the invention;

FIG. 2 is a flowchart illustrating an example of the operation of a system shown in FIG. 1;

FIG. 3 is a view showing a display example of a display screen of the system shown in FIG. 1;

FIG. 4 is a view showing another display example of the display screen of the system shown in FIG. 1;

FIG. 5 is a view showing a further display example of the display screen of the system shown in FIG. 1;

FIG. 6 is a diagram showing the configuration of a related-art duplex system; and

FIG. 7 is a diagram showing the configuration of duplicated modules.

### DETAILED DESCRIPTION OF THE PREFERRED EMBODIMENTS

An embodiment of the invention will be described with reference to the accompanying drawings.

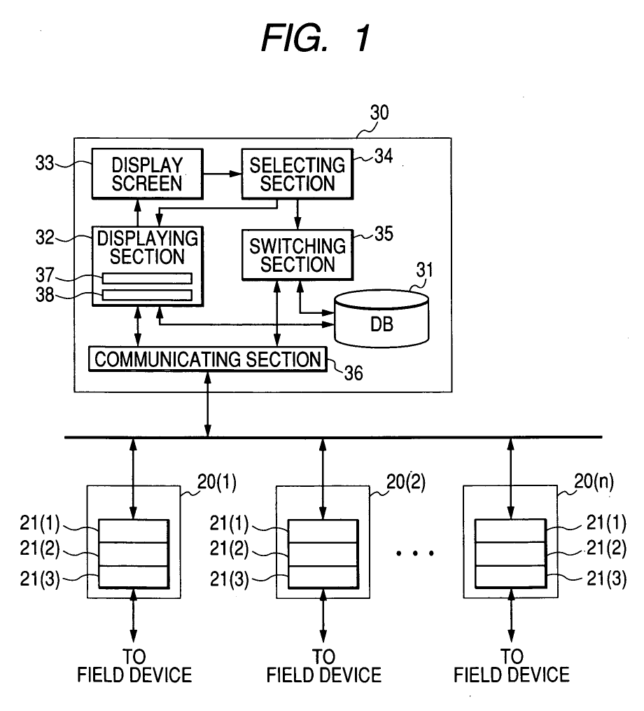

FIG. 1 is a diagram showing the configuration of an embodiment of the invention. The components identical with those of FIG. 6 are denoted by the same reference numerals, and their description is omitted. In FIG. 1, an HIS 30 is disposed in place of the HIS 10, and the HIS 30 communicates with the FCSs 20(1) to 20(n) to send and receive data. The HIS 30 is a higher-level device with respect to the FCSs 20(1) to 20(n).

The HIS 30 has a database 31, displaying section 32, a display screen 33, selecting section 34, switching section 35, and communicating section 36.

The database 31 is module information displaying section, and stores information of the input/output modules 23a, 23b. For example, information of the input/output modules 23a, 23b is at least one of the identifier, type, and installation place of each of the input/output modules 23a, 23b. Of course, also the identifier, type, and installation place of each of the FCSs 20(1) to 20(n) and the nodes 21(1) to 21(3) housing the input/output modules 23a, 23b are correlatedly stored as information. The database 31 stores the information in a hierarchical structure, and manages the information in the form of folders.

The FCSs 20(1) to 20(n) are previously provided with different identifiers (e.g., tags or names), respectively. The nodes 21(1) to 21(3) are previously provided with identifiers (e.g., node numbers) which are different from one another in each of the FCSs 20(1) to 20(n) where the nodes are disposed, respectively. The input/output modules 23a, 23b are previously provided with identifiers (e.g., slot numbers of the nodes 21(1) to 21(3)) which are different from one another in each of the nodes 21(1) to 21(3) where the input/output modules are disposed, respectively.

The displaying section 32 has module information displaying section 37 and status displaying section 38, reads information of the database 31, collects the statuses of the FCSs 20(1) to 20(n) and the like, and displays these data on the display screen 33.

The selecting section 34 is, for example, a mouse, a keyboard, or a touch panel, selects one of the input/output modules 23a, 23b displayed on the displaying section 32, and outputs a result of the selection to the displaying section 32 and the switching section 35.

The switching section 35 refers to the information of the database 31, and switches a control right of the input/output modules 23a, 23b selected by the selecting section 34 from the input/output module 23a on the control side to the input/output module 23b on the standby side. The communicating section 36 is mutually connected to the displaying section 32 and the switching section 35, and communicates with the FCSs 20(1) to 20(n) with a predetermined protocol.

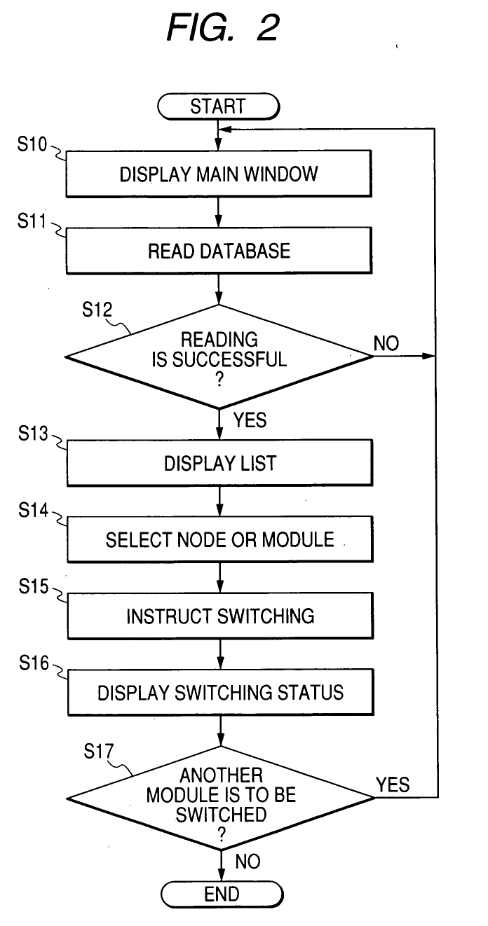

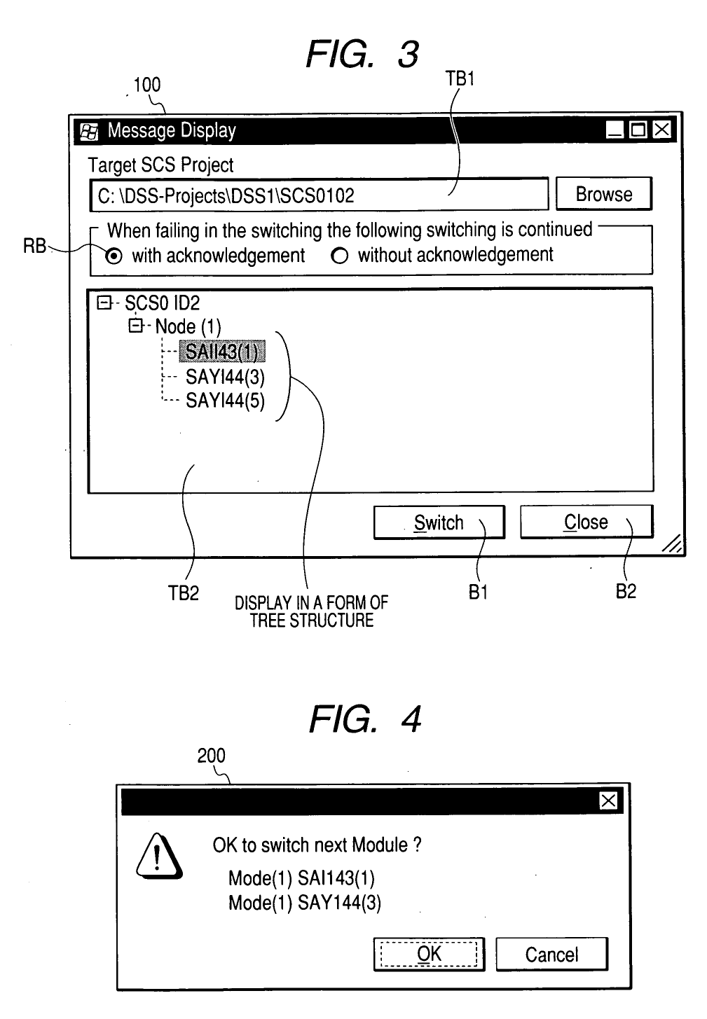

The operation of the thus configured system will be described. FIG. 2 is a chart illustrating the operation of the system shown in FIG. 1, and FIGS. 3 to 5 are views showing display examples of the display screen 33. The displaying section 32 displays a main window 100 shown in FIG. 3, on the display screen 33 (S10).

Then, the module information displaying section 37 reads module information from the database 31 (S11), and displays the information in the main window 100. In the case of the initial activation, a list of the input/output modules 23a, 23b which are stored in the database 31 is displayed in another window, and the operator selects one of the input/output modules 23a, 23b through the selecting section 34. In the second and subsequent activations, as shown in FIG. 3, the data path (folder path) in which information of the input/output modules 23a, 23b selected in the previous activation is displayed in a text box TB1. The module information displaying section 37 displays a list in a text box TB2 in each of the units of control station, node, and a pair of input/output modules. For example, the list is preferably displayed in the form of a tree structure of “control station name”—“node name (node number)”—“name of input/output module type (slot number)”. The displayed modules are modules which perform operations of inputting/outputting data to and from field devices, and which are duplicated (S12, S13).

If the data consistency, input/output module structure, or the like in the database 31 does not coincide, it is determined that reading fails, and the main window 100 is again displayed (S12, S10).

The operator selects the FCSs 20(1) to 20(n), the nodes 21(1) to 21(3), or the input/output modules 23a, 23b in which control is to be switched, through the selecting section 34, and presses a button B1 shown in FIG. 3. A confirmation window 200 shown in FIG. 4 may be displayed, and the selection may be confirmed. If confirmation is OK, the switching process is continued, and, if confirmation is cancelled, the process control is returned to the redisplay of the main window 100 (S14).

When the button B1 is pressed, the switching section 35 refers to the module information of the database 31, and instructs one of the FCSs 20(1) to 20(n) which includes the selected nodes 21(1) to 21(3) or input/output modules 23a, 23b, to switch a control right via the communicating section 36. Instruction receiving section (not shown) of the one of the FCSs 20(1) to 20(n) which receives the instructions switches the control right from the module 23a on the control side to the module 23b on the standby side. When the selecting section 34 performs selection in the unit of the FCSs 20(1) to 20(n) or the nodes 21(1) to 21(3), all the input/output modules 23a, 23b attached to the FCSs 20(1) to 20(n) or the nodes 21(1) to 21(3) collectively undergo the switching process (S15).

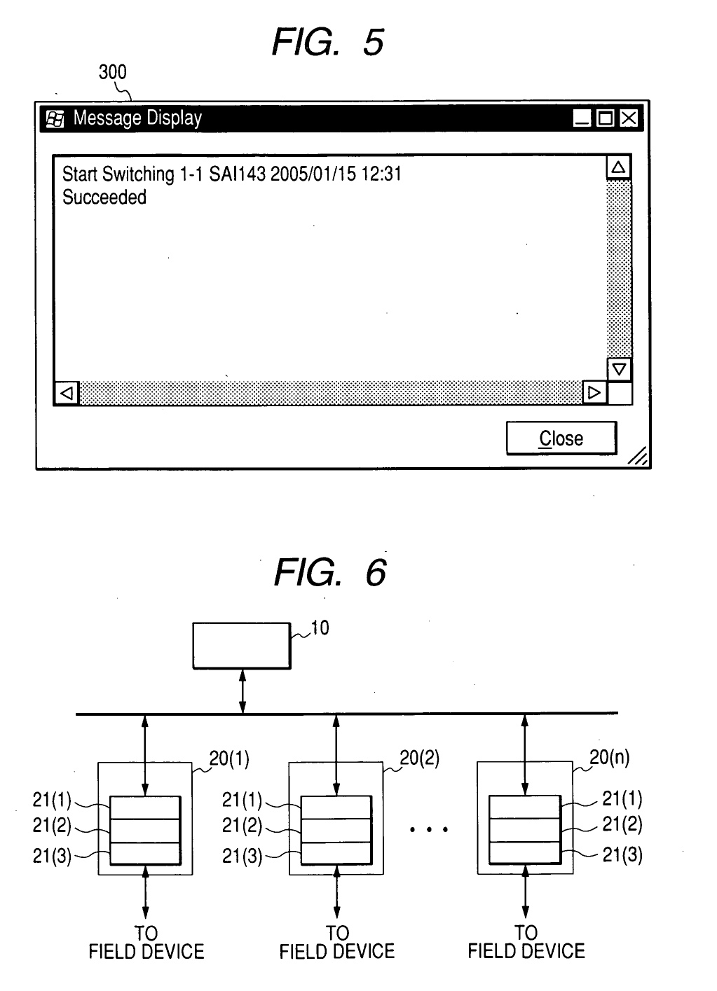

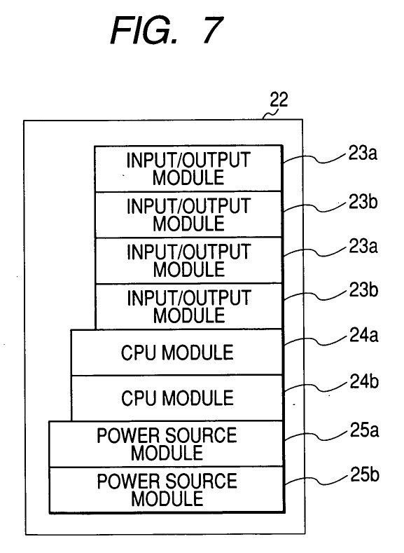

Then, the FCSs 20(1) to 20(n) sequentially transmit data of the switch status of the input/output modules 23a, 23b to the communicating section 36 of the HIS 30. The communicating section 36 supplies the data of the switch status to the displaying section 32. The status displaying section 38 displays the switch status of the input/output modules 23a, 23b, in a window 300 shown in FIG. 5. For example, the input/output modules which are to undergo the switching process are displayed, and the starting time of the switching process, a result of the switching process, the ending time of the switching process, a switching error, and the like are displayed for each of the input/output modules 23a, 23b. Of course, it is not necessary to display all kinds of the switch status, and only a kind(s) which is required by the operator, for example, information of an error may be displayed. Depending on selection of a radio button RB in the window 100 shown in FIG. 3, when an error occurs, the status displaying section 38 may display a confirmation dialog which requests confirmation of whether the switching process is performed on the next modules 23a, 23b (S16).

When, after the switching process is once ended, the switching process is to be continuously conducted, the selecting section 34 performs selection (S17, S10). When the switching process is to be ended, a button B2 is pressed through the selecting section 34, the displaying section 32 closes the main window 100, and the process is ended (S17).

In this way, the selecting section 34 disposed in the HIS 30 which is the higher-level device selects the input/output modules 23a, 23b which are displayed on the display screen 33 by the module information displaying section 37. Then, the switching section 35 switches the control right of the input/output modules 23a, 23b which are selected by the selecting section 34, from the control side to the standby side. Therefore, the operator is not required to shuttle between the HIS 30 and the control stations 20(1) to 20(n), or it is not necessary to deploy operators respectively in the HIS 30 and the FCSs 20(1) to 20(n). Consequently, the control right of the input/output modules 23a, 23b can be easily switched. Since the input/output modules 23a, 23b are not required to be detached, a situation where a detached input/output module 23a or 23b is erroneously attached to a wrong position, or where an input/output module is broken during an attaching or detaching process does not occur.

Since the selecting section 35 performs the selection in the unit of the FCSs 20(1) to 20(n) or the nodes 21(1) to 21(3), and the switching section 35 switches the control right in the selected unit, switching among plural input/output modules 23a, 23b can be instantaneously performed.

The invention is not restricted to the embodiment, and may be configured in the following manner.

In the above, the configuration in which the three nodes 21(1) to 21(3) are disposed in each of the FCSs 20(1) to 20(n) has been described. Any number of nodes may be disposed in each of the FCSs 20(1) to 20(n). Similarly, the FCSs 20(1) to 20(n), and the HIS 30 may be disposed at any number.

In the above, the configuration in which the database 31, the displaying section 32, the display screen 33, the selecting section 34, and the switching section 35 are disposed in the HIS 30 has been described. Alternatively, only the database 31 may be disposed in an external device (for example, a computer) other than the HIS 30, or all of the components may be disposed in an external device. Of course, the external device is a higher-level device of the FCSs 20(1) to 20(n).

The identifiers of the nodes 21(1) to 21(3) and the modules 23a, 23b may be provided so as to be different for one another in the plant, and stored into the database 31.

What is claimed is:

1. A duplex system, comprising:
a control station which has a pair of input/output modules duplicated on control and standby sides, which is disposed between a higher-level device and a lower-level device, and which sends and receives data;
a module information storing section which stores information of the pair of input/output modules provided in the control station;
a module information displaying section which displays information stored in the module information storing section;
a selecting section which selects at least one pair out of input/output modules displayed on the module information displaying section; and
a switching section which switches a control right of the pair of input/output modules selected by the selecting section from the control side to the standby side.

2. The duplex system according to claim 1,
wherein the module information storing section stores as least one of an identifier, a type, and an installation place of each of the pair of input/output modules, as the information.

3. The duplex system according to claim 2,
wherein the module information displaying section displays the information in a unit of a control station, a node in a control station, or a pair of input/output modules.

4. The duplex system according to claim 3,
wherein the selecting section selects a pair of input/output modules in a unit of a control station, a node in a control station, or a pair of input/output modules.

5. The duplex system according to claim 3,
wherein the module information displaying section displays the information with a tree structure.

6. The duplex system according to claim 1, further comprising:
a status displaying section which displays a switching status of a control right of a pair of input/output modules.

7. The duplex system according to claim 6,
wherein the status displaying section displays at least one of a pair of input/output modules for which a switching process is performed, a starting time of the switching process, a result of the switching process, an ending time of the switching process, and a switching error.

8. The duplex system according to claim 1,
wherein the duplex system is used in a plant control system.

9. A method of switching a control right in a duplex system comprising a control station which has a pair of input/output modules duplicated on control and standby sides, which is disposed between a higher-level device and a lower-level device, and which sends and receives data, comprising the steps of:
storing information of the pair of input/output modules provided in the control station, into a module information storing section;
reading information stored in the module information storing section to display a list of pairs of input/output modules;
selecting at least one pair out of input/output modules displayed; and
switching a control right of the pair of input/output modules selected from the control side to the standby side.
